(19) United States
(12) Patent Application Publication
(10) Pub. No.: US 2003/0012096 A1
(43) Pub. Date: Jan. 16, 2003

(54) Disk drive device

(75) Inventors: Nakayuki Kitaoka, Osaka (JP); Yasuo Nakata, Osaka (JP); Masanori Harui, Osaka (JP)

Correspondence Address: MICHAEL E. FOGARTY, MCDERMOTT, WILL & EMERY, 600 13TH STREET, NW, WASHINGTON, DC, 20005-3096, US

(73) Assignee: Matsushita Electric Industrial Co., Ltd.

(21) Appl. No.: 10/195,380

(22) Filed: Jul. 16, 2002

(30) Foreign Application Priority Data
Jul. 16, 2001 (JP) 2001-215421

(51) Int. Cl. G11B 7/00

(52) U.S. Cl. 369/44.29; 369/53.28

(57) ABSTRACT

A relative traveling speed detector receives a focus error signal and detects a traveling speed of a pickup relative to a disk. A drive mode determining unit determines a drive mode of the pickup according to the detected relative traveling speed. A drive output generating means generates a focus drive signal for driving the pickup according to the drive mode. The disk drive device is thus capable of reducing the time required to restore a focus servo operation.

### BACKGROUND OF THE INVENTION

The present invention relates to a disk drive device capable of reducing the time required to restore a focus servo operation.

In the disk devices such as CD (Compact Disk) and DVD (Digital Versatile Disk), data spirally recorded on a disk is read with laser light from a pickup during rotation of the disk. This read operation includes the following two controls: focus control for focusing laser light from the pickup on the data on a track; and tracking control for positioning the pickup at a prescribed track position on the disk.

In the focus control, the displacement amount of the pickup from an in-focus position is commonly detected by an astigmatism method. In the astigmatism method, laser light is output from a laser diode and reflected back from the disk into a four-quadrant photodetector through a condenser lens and a semicylindrical lens. Since astigmatism is generated by the condenser lens and the semicylindrical lens, the reflected laser light produces a spot of a perfect circle on the four-quadrant photodetector when the laser light is in focus, but produces an elliptical spot when the laser light is out of focus. Therefore, the difference between the sum of the outputs of one pair of diagonally opposed quadrants of the four-quadrant photodetector and the sum of the outputs of the other pair will be equal to zero when the laser light is in focus. When the laser light is out of focus, however, the difference will have a value in proportion to the defocus amount. In the focus control, this value is used as a focus error signal in the focusing direction of the pickup. The focus control is conducted so that the focus error signal becomes equal to zero.

As shown by the focus error signal of FIG. 10, however, if the laser light is excessively defocused (i.e., if the pickup is in a defocus region 82), it will not be collected on the four-quadrant photodetector. Therefore, a proper focus error signal will not be detected. For effective focus control, the pickup must be moved into an in-focus region 81 (i.e., the region where a proper focus error signal is detected) toward the in-focus position 80 by open control. Note that, as shown in FIG. 10, since the profile of the focus error signal looks like an S-shape, the waveform of the focus error signal is sometimes called “S-shaped waveform”.

FIG. 11 is a block diagram showing an example of a conventional disk drive device. The conventional disk drive device in FIG. 11 includes a disk 71, a spindle motor 72, a pickup 73, a head amplifier 74, a servo filter operation unit 75, a pickup driver 76, an in-focus/defocus determining unit 77, a triangular wave generator 78, a servo ON/OFF switch SW10, and a driver output switch SW11. In FIG. 11, 73S denotes various read signals, and 74S denotes a focus error signal.

In the conventional disk drive device, the disk 71 is rotated by the spindle motor 72. The disk 71 has tracks with spirally written data. The data on the tracks is read with laser light from the pickup 73. In order to read the data properly, the laser light from the pickup 73 must be focused on the data. A focus error signal S74 in the in-focus region of the pickup 73 is generated only in a narrow range. Therefore, a focus scanning operation (operation of driving the pickup 73 in the focusing direction) must be conducted before the focus control so that the pickup 73 is moved to a position where the focus error signal 74S in the in-focus region can be detected.

In the initial state of the disk drive device of FIG. 11, the servo ON/OFF switch SW10 is in the OFF state, and the drive output switch SW11 selects the triangular wave generator 78. In response to an instruction to start the focus control, the triangular wave generator 78 outputs a triangular wave for driving the pickup 73 in the focusing direction.

While the pickup driver 76 is driving the pickup 73 in response to the triangular wave, the in-focus/defocus determining unit 77 keeps track of the focus error signal 74S and various read signals 73S. If the in-focus/defocus determining unit 77 determines that the pickup 73 is in the in-focus region, the driver output switch SW11 is switched to the servo filter operation unit 75 and the servo ON/OFF switch SW10 is turned ON, whereby the focus control is activated for focus servo operation. Since the focus error signal 74S in the in-focus region can now be detected, the focus servo operation can be conducted properly. If the focus error signal S74 in the in-focus region is not detected by driving the pickup 73 to a prescribed level, the triangular wave generator 78 outputs a triangular wave having the opposite polarity. In other words, the pickup 73 is driven in the opposite direction in order to restore the focus servo operation.

If the pickup 73 moves into the defocus region during the focus servo operation due to vibration or the like, the focus control cannot be continued any more and the focus servo operation is discontinued. As a result, the position of the pickup 73 becomes unknown. In this case, the focus servo operation is restored by switching the driver output switch SW11 to the triangular wave generator 78 and turning OFF the servo ON/OFF switch SW10 so that the triangular wave generator 78 generates a triangular wave for driving the pickup 73.

Another way to restore the focus servo operation in the above situation is as follows: FIG. 12 is a block diagram showing another example of the conventional disk drive device. The disk drive device of FIG. 12 includes a traveling-direction detector 81, a focus brake signal generator 82, a timer 83 and a switch SW12 in addition to the components of FIG. 11. The switch SW12 is switched between the focus brake signal generator 82 and the triangular wave generator 78. The same components as those of FIG. 11 are denoted with the same reference numerals and characters.

During the focus servo operation, the servo ON/OFF switch SW10 is in the ON state, and the driver output switch SW11 selects the servo filter operation unit 75. If the pickup 73 moves into the defocus region due to vibration or the like, the driver output switch SW11 is switched to the switch SW12, and the switch SW12 is switched to the focus brake signal generator 82. At the same time, the focus brake signal generator 82 receives an instruction to start a braking operation from the in-focus/defocus determining unit 77, and receives information on the braking direction from the traveling direction detector 81. In response to the instruction, the focus brake signal generator 82 outputs a brake pulse in such a direction that stops the pickup 73. The in-focus/defocus determining unit 77 keeps track of the focus error signal 74S while the brake pulse is output. When the in-focus/defocus determining unit 77 determines that the pickup 73 reaches the in-focus region by the brake pulse, it instructs the focus brake signal generator 82 to stop outputting the brake pulse. At the same time, the driver output switch SW11 is switched to the servo filter operation unit 75 and the servo ON/OFF switch SW10 is turned ON. The focus servo operation is thus restored.

However, the above conventional disk drive devices have the following problems: when the focus servo operation is discontinued due to vibration or the like, it is difficult to drive the pickup in the focusing direction due to rapid vibration of the pickup. If an attempt is nevertheless made to restore the focus servo operation, the pickup would vibrate all the more violently. Therefore, it takes a long time to restore the focus servo operation.

Moreover, the above conventional disk drive devices restore the focus servo operation by searching the in-focus region by the focus scanning operation (operation of driving the pickup in the focusing direction). In this method, it takes a long time for the pickup to reach the in-focus region, and therefore it takes a long time to restore the focus servo operation.

### SUMMARY OF THE INVENTION

It is an object of the present invention to provide a disk drive device capable of reducing the time required to restore a focus servo operation.

More specifically, according to a first aspect of the present invention, a disk drive device includes a pickup for outputting laser light to a disk for reading data recorded on the disk, a relative traveling speed detecting means for receiving a focus error signal indicating a displacement amount of the pickup from an in-focus position and detecting a traveling speed of the pickup relative to the disk, a drive mode determining means for receiving the detected relative traveling speed and determining a drive mode of the pickup according to the received relative traveling speed, and a drive output generating means for generating a focus drive signal for driving the pickup according to the drive mode.

In the first aspect of the present invention, if a focus servo operation is discontinued, the traveling speed of the pickup relative to the disk is detected and the drive mode of the pickup is switched according to the detection result. More specifically, if it is determined that the focus servo operation can be restored at the detected relative traveling speed, an operation of restoring the focus servo operation is started. On the other hand, if it is determined that the focus servo operation cannot be restored at the detected relative traveling speed, a brake pulse is applied. This facilitates restoration of the pickup to the in-focus region, thereby reducing the time required to restore the focus servo operation.

Preferably, the drive mode determining means determines that the drive mode is a brake mode when the relative traveling speed is greater than a prescribed value, and determines that the drive mode is a mode for restoring a focus servo operation when the relative traveling speed is smaller than the prescribed value.

Preferably, the relative traveling speed detecting means detects the relative traveling speed by measuring a time required for the focus error signal to reach a second threshold value after becoming higher or lower than a first threshold value.

Preferably, the relative traveling speed detecting means detects the relative traveling speed by measuring a gradient of the focus error signal between a first preset value and a second preset value of the focus error signal.

According to a second aspect of the present invention, a disk drive device includes a pickup for outputting laser light to a disk for reading data recorded on the disk, an in-focus/defocus determining means for receiving a focus error signal indicating a displacement amount of the pickup from an in-focus position and an output signal of the pickup, and determining whether the pickup is in an in-focus region or in a defocus region, a drive output generating means for generating a focus drive signal for driving the pickup, and a focus drive hold signal generating means for generating a focus drive hold signal for holding the focus drive signal when the in-focus/defocus determining means determines that the pickup is in the defocus region. The drive output generating means holds the focus drive signal in response to the focus drive hold signal.

In the second aspect of the present invention, if a focus servo operation is discontinued, the focus drive signal is held and the focus scanning operation is not conducted. This facilitates restoration of the pickup to the in-focus region, and also increases the number of chances to detect a proper focus error signal. As a result, the time required to restore the focus servo operation can be reduced.

According to a third aspect of the present invention, a disk drive device includes a pickup for outputting laser light to a disk for reading data recorded on the disk, an in-focus/defocus determining means for receiving a focus error signal indicating a displacement amount of the pickup from an in-focus position and an output signal of the pickup, and determining whether the pickup is in an in-focus region or in a defocus region, a drive output generating means for generating a focus drive signal for driving the pickup, and a small drive signal generating means for generating a small drive signal for driving the pickup with an amplitude smaller than a normal amplitude, when the in-focus/defocus determining means determines that the pickup is in the defocus region. The drive output generating means generates a focus drive signal for driving the pickup with an amplitude smaller than the normal amplitude, in response to the small drive signal.

In the third aspect of the present invention, if the focus servo operation is discontinued, a focus scanning operation is conducted with an amplitude smaller than that used in a normal focus scanning operation. Since the pickup hardly moves, this facilitates restoration of the pickup to the in-focus region, and also increases the number of chances for the pickup to reach the in-focus region. As a result, the time required to restore the focus servo operation can be reduced. Moreover, the focus scanning operation is conducted while driving the pickup with small driving force. As a result, the focus servo operation can be restored even if the vibration center of the pickup is displaced from the center of the pickup for the focus scanning operation.

Preferably, the disk drive device further includes a counting means for detecting whether or not restoration of a focus servo operation is completed within a prescribed time after an operation of restoring the focus servo operation is started. When the counting means detects that restoration of the focus servo operation is not completed within the prescribed time, the disk drive device discontinues the operation of restoring the focus servo operation and proceeds to another operation of restoring a focus servo operation.

Preferably, the disk drive device further includes an S-shape detecting means for detecting an S-shaped waveform of the focus error signal, and a counting means for measuring a time required for the S-shape detecting means to detect the S-shaped waveform. When the time measured by the counting means exceeds a prescribed value, the disk drive device proceeds to another operation of restoring a focus servo operation.

Preferably, the disk drive device further includes an S-shape detecting means for detecting an S-shaped waveform of the focus error signal, and an S-shape counter for counting the number of times the S-shape detecting means detects the S-shaped waveform. When the count value of the S-shape counter exceeds a prescribed value, the disk drive device proceeds to another operation of restoring a focus servo operation.

### BRIEF DESCRIPTION OF THE DRAWINGS

FIG. 1 is a block diagram showing the structure of a disk drive device according to a first embodiment of the present invention;

FIGS. 2A and 2B illustrate a method for detecting a relative traveling speed in first and fourth embodiments of the present invention;

FIG. 3 illustrates the timing of restoring a focus servo operation in the first embodiment of the present invention;

FIG. 4 is a block diagram showing the structure of a disk drive device according to a second embodiment of the present invention;

FIGS. 5A, 5B and 5C illustrate the timing of restoring a focus servo operation in the second embodiment of the present invention;

FIG. 6 shows a modification of the disk drive device according to the second embodiment of the present invention;

FIG. 7 shows another modification of the disk drive device according to the second embodiment of the present invention;

FIG. 8 is a block diagram showing the structure of a disk drive device according to a third embodiment of the present invention;

FIG. 9 is a block diagram showing the structure of a disk drive device according to a fourth embodiment of the present invention;

FIG. 10 is a timing chart of a focus error signal;

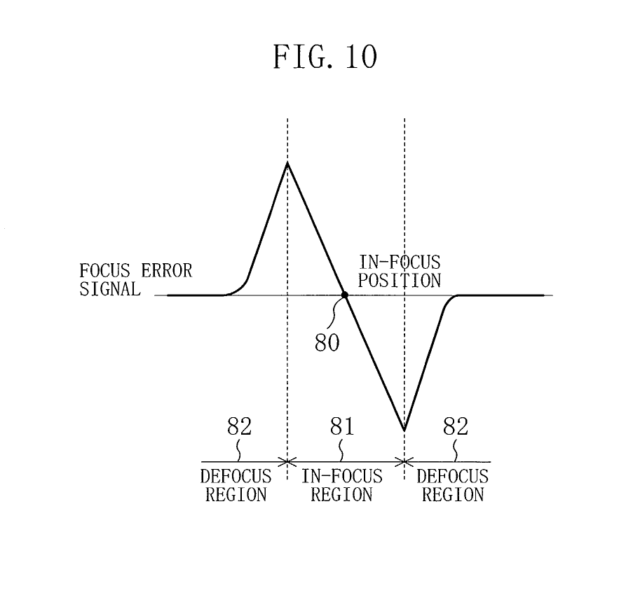

FIG. 11 is a block diagram showing an example of a conventional disk drive device; and

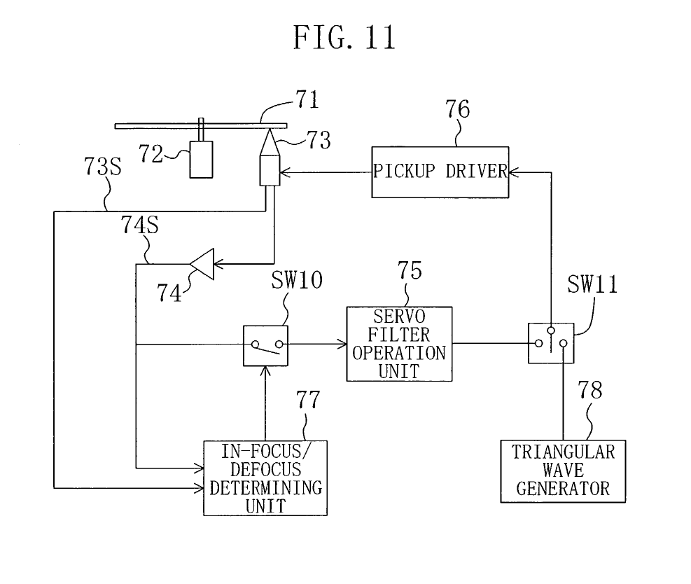

FIG. 12 is a block diagram showing another example of the conventional disk drive device.

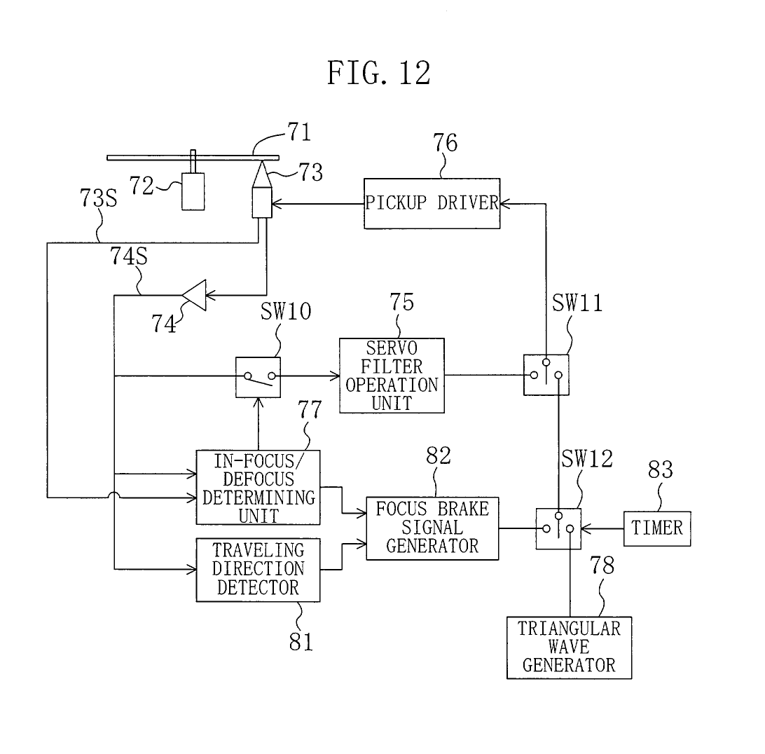

### DESCRIPTION OF THE PREFERRED EMBODIMENTS

Hereinafter, embodiments of the present invention will be described with reference to the accompanying drawings.

(First Embodiment)

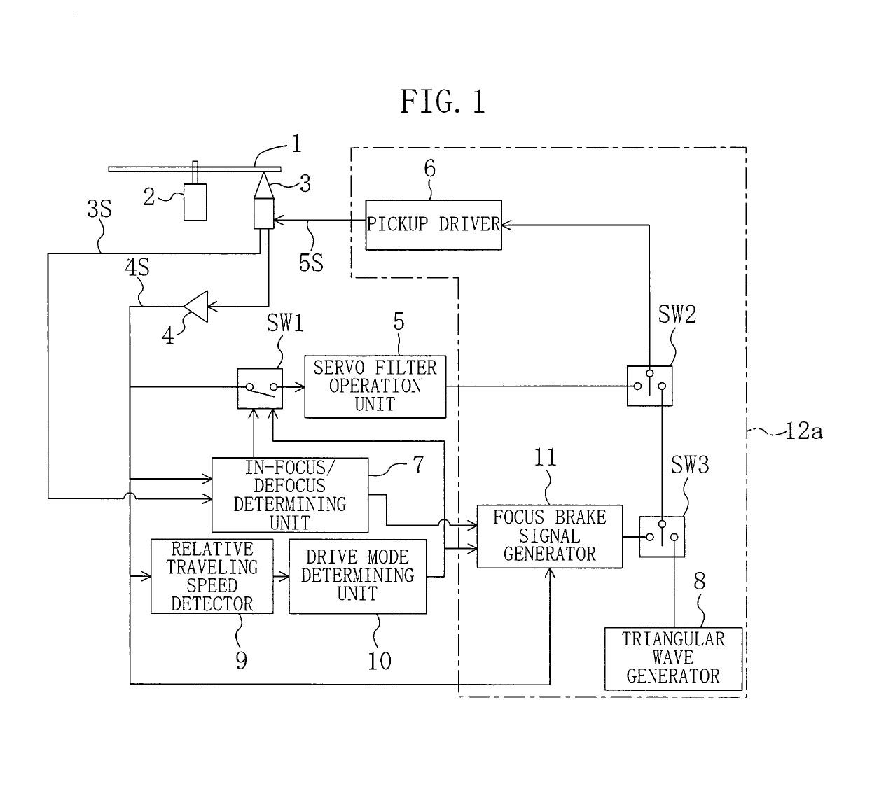

The first embodiment of the present invention will now be described with reference to FIGS. 1 to 3.

FIG. 1 is a block diagram showing the structure of a disk drive device according to the first embodiment. The disk drive device of FIG. 1 includes a disk 1, a spindle motor 2, a pickup 3, a head amplifier 4, a servo filter operation unit 5, a pickup driver 6, an in-focus/defocus determining unit 7, a triangular wave generator 8, a relative traveling speed detector 9 (corresponding to a relative traveling speed detecting means), a drive mode determining unit 10 (corresponding to a drive mode determining means), a focus brake signal generator 11, a servo ON/OFF switch SW1, a driver output switch SW2, and a switch SW3. The switch SW3 is switched between the focus brake signal generator 11 and the triangular wave generator 8. A drive output generating means 12a is formed by the pickup driver 6, the triangular wave generator 8 and the focus brake signal generator 11.

In the disk drive device of the present embodiment, the disk 1 is rotated by the spindle motor 2. In the initial state, the servo ON/OFF switch SWI is in the OFF state, the drive output switch SW2 selects the switch SW3, and the switch SW3 selects the triangular wave generator 8. In response to an instruction to start the focus control, the triangular wave generator 8 outputs a triangular wave for driving the pickup 3 in the focusing direction.

In response to the triangular wave, the pickup driver 6 outputs a focus drive signal 5S for driving the pickup 3. While the pickup driver 6 is driving the pickup 3 with the focus drive signal 5S, the in-focus/defocus determining unit 7 keeps track of a focus error signal 4S and various read signals 3S, and determines whether the pickup 3 is in the in-focus region or in the defocus region. If the in-focus/defocus determining unit 7 determines that the pickup 3 is in the in-focus region, the driver output switch SW2 is switched to the servo filter operation unit 5 and the servo ON/OFF switch SW1 is turned ON, whereby the focus control is activated for focus servo operation.

During the focus servo operation, the in-focus/defocus determining unit 7 keeps track of the focus error signal 4S and various read signals 3S. If the in-focus/defocus determining unit 7 determines that the pickup 3 moves into the defocus region due to vibration or the like, the servo ON/OFF switch SW1 is turned OFF, the driver output switch SW2 is switched to the switch SW3, and the switch SW3 is switched to the triangular wave generator 8. The triangular wave generator 8 then applies a triangular wave signal to the pickup driver 6, which in turn outputs a focus drive signal 5S for driving the pickup 3 in the focusing direction. The pickup 3 is thus driven in the focusing direction, and a focus scanning operation is conducted. During the focus scanning operation as well, the in-focus/defocus determining unit 7 keeps track of the focus error signal 4S and various read signals 3S to determine whether the pickup 3 is in the in-focus region or in the defocus region. While the focus scanning operation is conducted, the relative traveling speed detector 9 detects the traveling speed of the pickup 3 relative to the disk 1 according to the focus error signal 4S. The drive mode determining unit 10 determines the drive mode of the pickup 3 based on the detected relative traveling speed.

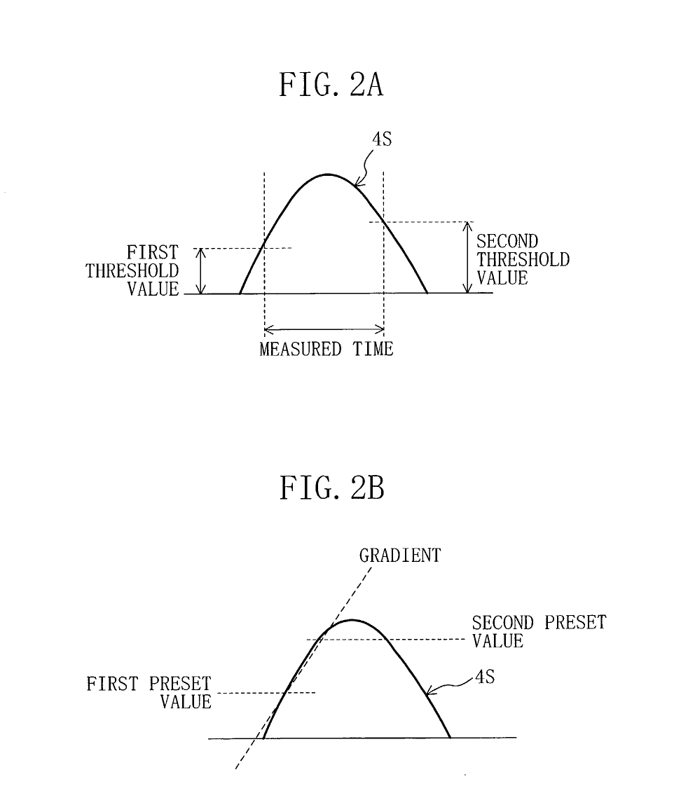

Hereinafter, a method for detecting the relative traveling speed and determination of the drive mode will be described with reference to FIGS. 2A and 2B.

FIG. 2A illustrates a method for detecting the relative traveling speed using threshold values. The relative traveling speed detector 9 receives a focus error signal 4S and starts measuring the time when the focus error signal 4S exceeds a first threshold value. The relative traveling speed detector 9 stops measuring the time when the focus error signal 4S falls to a second threshold value from the peak. If the measured time is equal to or greater than a preset value, the drive mode determining unit 10 determines that the pickup 3 moves slowly relative to the disk 1, and therefore determines that the drive mode of the pickup 3 is a mode for restoring a focus servo operation. If the measured time is smaller than the preset value, the drive mode determining unit 10 determines that the pickup 3 vibrates violently and moves rapidly relative to the disk 1. Accordingly, the drive mode determining unit 10 determines that it is impossible to restore the focus servo operation, and that the drive mode of the pickup 3 is a brake mode.

Note that, in the detection method of FIG. 2A, the focus error signal 4S has an S-shape waveform with its peak facing upward. When the focus error signal 4S has an S-shape waveform with its peak facing downward, the relative traveling speed is detected in the manner opposite to that described above. More specifically, the relative traveling speed detector 9 starts measuring the time when the focus error signal 4S becomes lower than a first threshold value, and stops measuring the time when the focus error signal 4S rises to a second threshold value from the peak.

FIG. 2B illustrates a method for detecting the relative traveling speed using the gradient. The relative traveling speed detector 9 receives a focus error signal 4S and starts measuring the time when the focus error signal 4S reaches a first preset value. The relative traveling speed detector 9 stops measuring the time when the focus error signal 4S reaches a second preset time, and obtains the gradient of the focus error signal 4S for the measured time. If the gradient is smaller than a preset value, the drive mode determining unit 10 determines that the pickup 3 moves slowly relative to the disk 1 and that the drive mode of the pickup 3 is a mode for restoring a focus servo operation. On the other hand, if the gradient is equal to or greater than the preset value, the drive mode determining unit 10 determines that the pickup 3 vibrates violently and moves rapidly relative to the disk 1. Accordingly, the drive mode determining unit 10 determines that it is impossible to restore the focus servo operation, and that the drive mode of the pickup 3 is a brake mode.

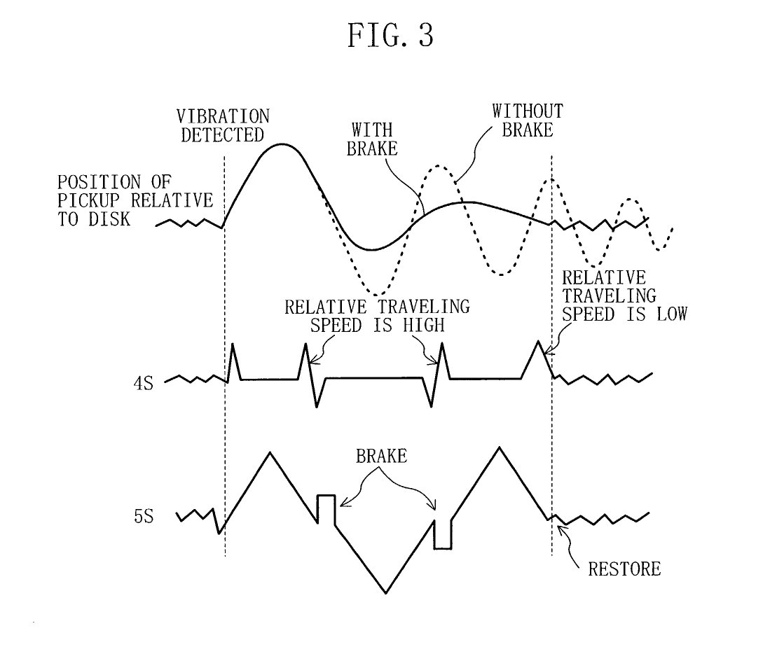

In this case, the focus servo operation is restored at the timing shown in FIG. 3. As shown in FIG. 3, when the drive mode determining unit 10 determines that the drive mode is a brake mode, the switch SW3 is switched to the focus brake signal generator 11 so as not to restore the focus servo operation. The focus brake signal generator 11 applies a brake pulse to the pickup driver 6 in order to suppress the vibration of the pickup 3. As soon as the application of the brake pulse is completed, the switch S3 is switched back to the triangular wave generator 8 so as to restore the focus servo operation. The triangular wave generator 8 applies a triangular wave to the pickup driver 6. The pickup driver 6 outputs a focus drive signal 5S (signal for driving the pickup 3) to the pickup 3, whereby the disk drive device proceeds to a focus scanning operation. On the other hand, if the drive mode determining unit 10 determines that the pickup 3 moves slowly relative to the disk 1, it is possible to restore the focus servo operation. Therefore, when the pickup 3 reaches the in-focus region, the switch SW3 is switched back to the triangular wave generator 8 for the focus servo operation.

As has been described above, if the focus servo operation is discontinued in the first embodiment, the traveling speed of the pickup relative to the disk is detected and the drive mode of the pickup is switched according to the detection result. More specifically, if it is determined that the focus servo operation can be restored at the detected relative traveling speed, the operation of restoring the focus servo operation is started. On the other hand, if it is determined that the focus servo operation cannot be restored at the detected relative traveling speed, a brake pulse is applied. Application of the brake pulse prevents excessive vibration of the pickup and also prevents the pickup from jumping into the defocus region. This facilitates restoration of the pickup to the in-focus region, thereby reducing the time required to restore the focus servo operation.

(Second Embodiment)

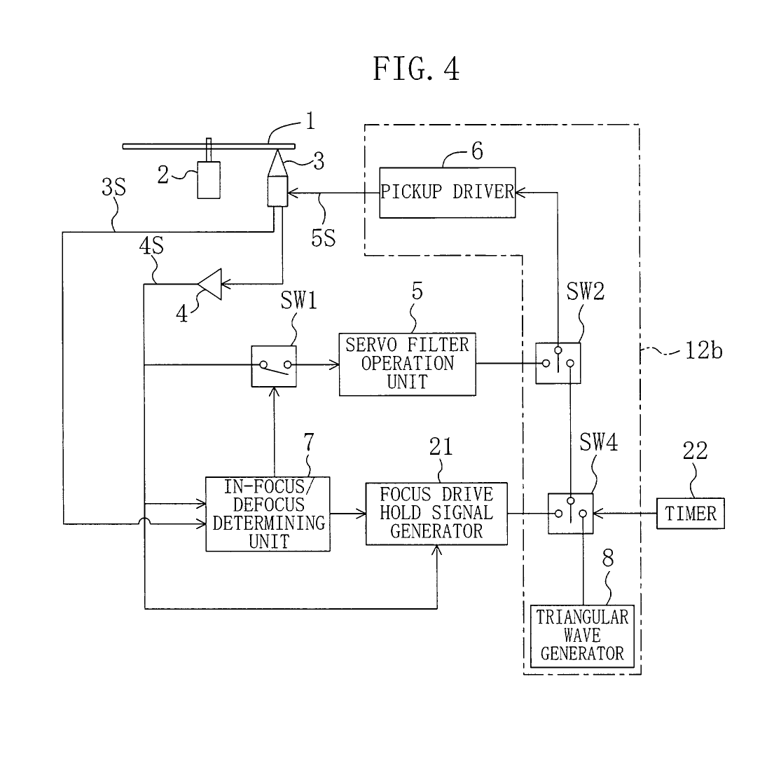

Hereinafter, the second embodiment of the present invention will be described with reference to FIGS. 4 to 7.

FIG. 4 is a block diagram showing the structure of a disk drive device according to the second embodiment. In the disk drive device of FIG. 4, the same components as those in FIG. 1 are denoted with the same reference numerals and characters. The disk drive device of FIG. 4 additionally includes a focus drive hold signal generator 21 (corresponding to a focus drive hold signal generating means), a timer 22 (corresponding to a counting means) and a switch SW4. The switch SW4 is switched between the focus drive hold signal generator 21 and the triangular wave generator 8. A drive output generating means 12b is formed by the pickup driver 6 and the triangular wave generator 8.

In the initial state, the servo ON/OFF switch SW1 is in the ON state, the driver output switch SW2 selects the switch SW4, and the switch SW4 selects the triangular wave generator 8. In response to an instruction to start the focus control, a focus servo operation is conducted in the same manner as that described in the first embodiment.

When the pickup 3 is in the in-focus region in the focus servo operation, the servo ON/OFF switch SW1 is in the ON state, and the driver output switch SW2 selects the servo filter operation unit 5. The in-focus/defocus determining unit 7 (corresponding to an in-focus/defocus determining means) keeps track of a focus error signal 4S and various read signals 3S to determine whether the pickup 3 is in the in-focus region or in the defocus region. If the in-focus/defocus determining unit 7 determines that the pickup 3 moves into the defocus region due to vibration or the like, the servo ON/OFF switch SW1 is turned OFF, and the driver output switch SW2 is switched to the switch SW4. The switch SW4 is switched to the focus drive hold signal generator 21. The focus drive hold signal generator 21 generates a focus drive hold signal for holding a focus drive signal 5S for driving the pickup driver 6.

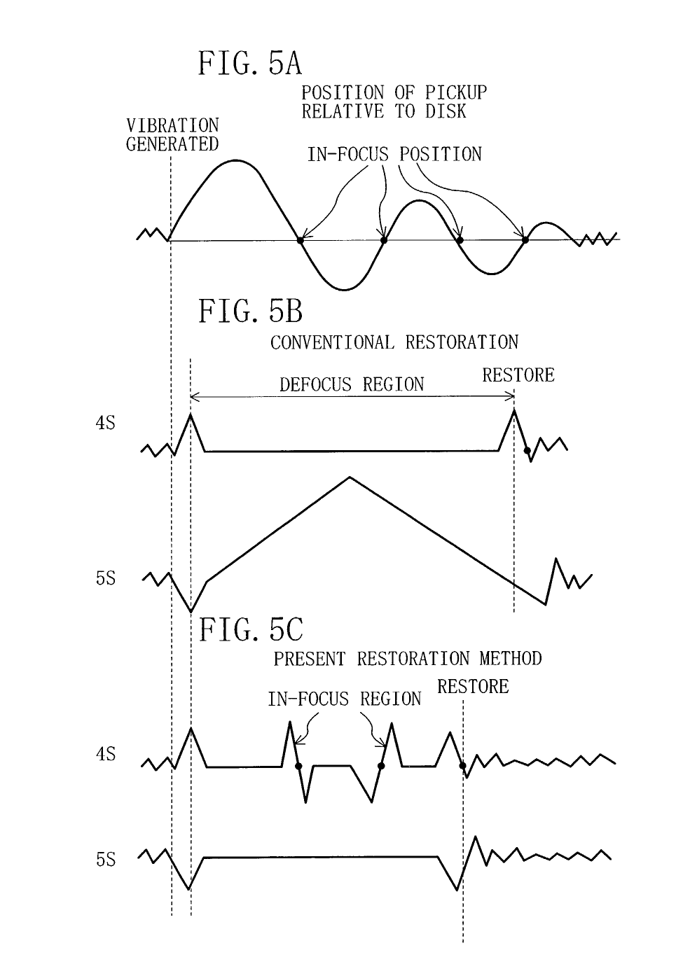

In this case, the focus servo operation is restored at the timing shown in FIGS. 5A to 5C. FIGS. 5A to 5C illustrate the timing of restoring the focus servo operation in the present embodiment. Conventionally, the pickup 3 is driven in the focusing direction for the focus scanning operation, as shown in FIG. 5B. In the present embodiment, however, since the disk 1 and the pickup 3 vibrate, the focus drive signal 5S is held and the pickup 3 is not driven in the focusing direction, as shown in FIG. 5C. This enables the pickup 3 to detect the in-focus region earlier than in the conventional example, and also increases the number of chances for the pickup 3 to detect the in-focus region as compared to the conventional example. As a result, the time required to restore the focus servo operation can be reduced.

The timer 22 starts a counting operation as soon as the focus drive signal 5S is held, and discontinues the counting operation when restoration of the focus servo operation is completed. If restoration of the focus servo operation is not completed at a prescribed count value or more, the focus drive signal 5S is held, and it is determined that any trouble occurred during restoration of the focus servo operation. In this case, the switch SW4 is switched to the triangle wave generator 8, whereby the disk drive device proceeds to a normal focus scanning operation to restore the focus servo operation.

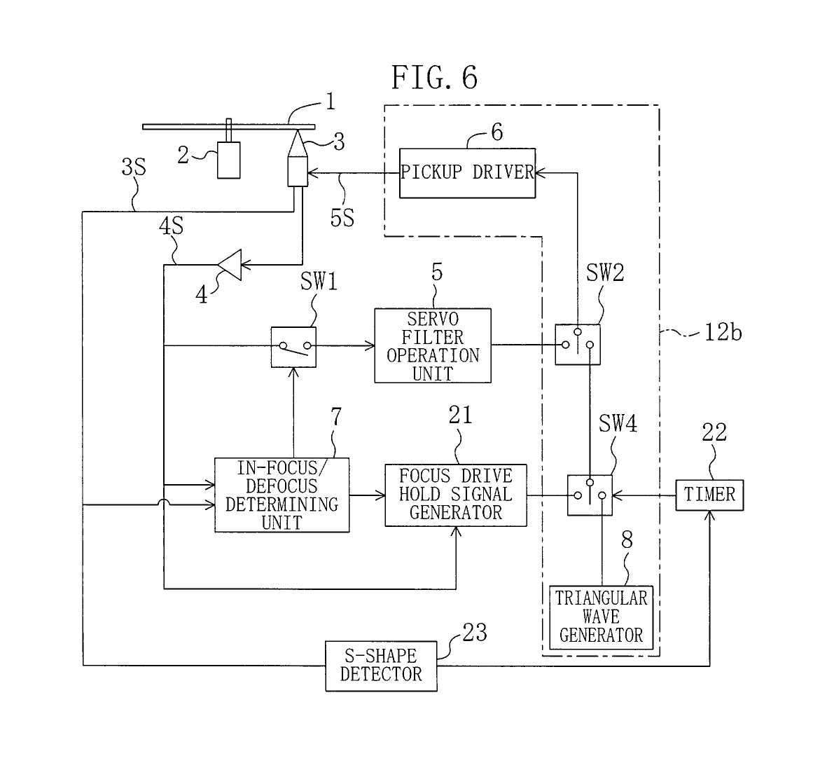

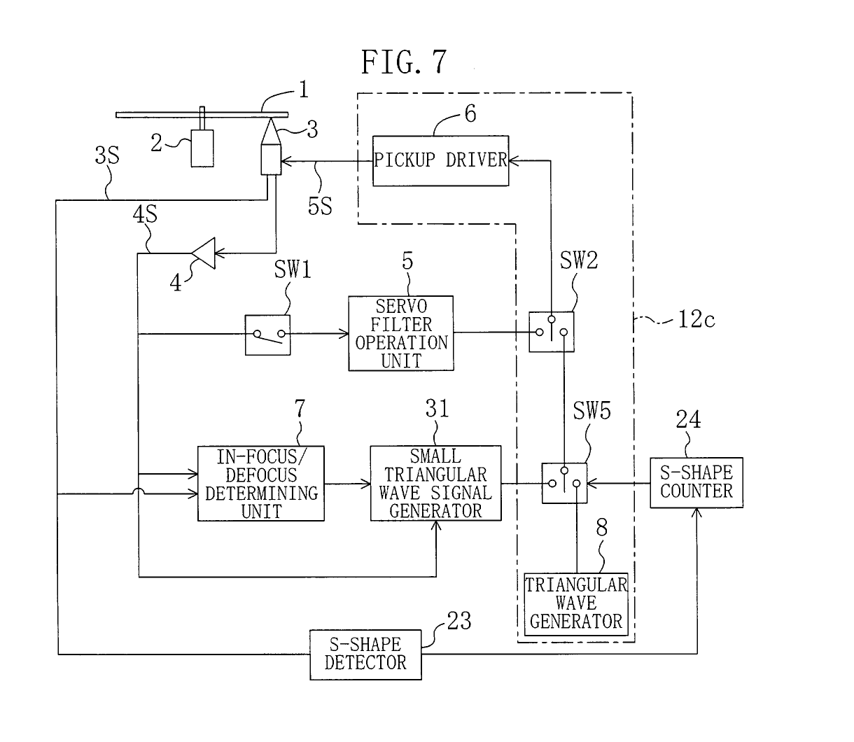

As modifications of the second embodiment, the disk drive device may proceed to the normal focus scanning operation in the following manner: FIGS. 6 and 7 show modifications of the disk drive device of the second embodiment. The disk drive device of FIG. 6 includes an S-shape detector 23 (corresponding to an S-shape detecting means) in addition to the components of the disk drive device of FIG. 4. The S-shape detector 23 starts detecting the S-shape waveform of the focus error signal 4S as soon as the focus drive signal 5S is held. The time 22 measures the time required for the S-shape detector 23 to detect the S-shape waveform. In this modification, the disk drive device proceeds to the normal focus scanning operation when the time measured by the timer 22 exceeds a prescribed value. As shown in FIG. 7, the timer 22 of FIG. 6 may be replaced with an S-shape counter 24. The S-shape counter 24 counts the number of times the S-shape detector 23 detects the S-shape waveform. In this modification, the disk drive device proceeds to the normal focus scanning operation when the count value of the S-shape counter 24 exceeds a prescribed value.

Note that the above modifications are applicable to the first embodiment. The same control as that in the above modifications can be implemented by merely adding either the S-shape detector 23 and the timer 22 or the S-shape detector 23 and the S-shape counter 24 to the disk drive device of the first embodiment, as shown in FIGS. 6 and 7.

As has been described above, if the focus servo operation is discontinued in the second embodiment, the focus drive signal is held and the focus scanning operation is not conducted. This facilitates restoration of the pickup to the in-focus region without driving the pickup in the focus direction, and also increases the number of chances to detect a proper focus error signal. As a result, the time required to restore the focus servo operation can be reduced.

(Third Embodiment)

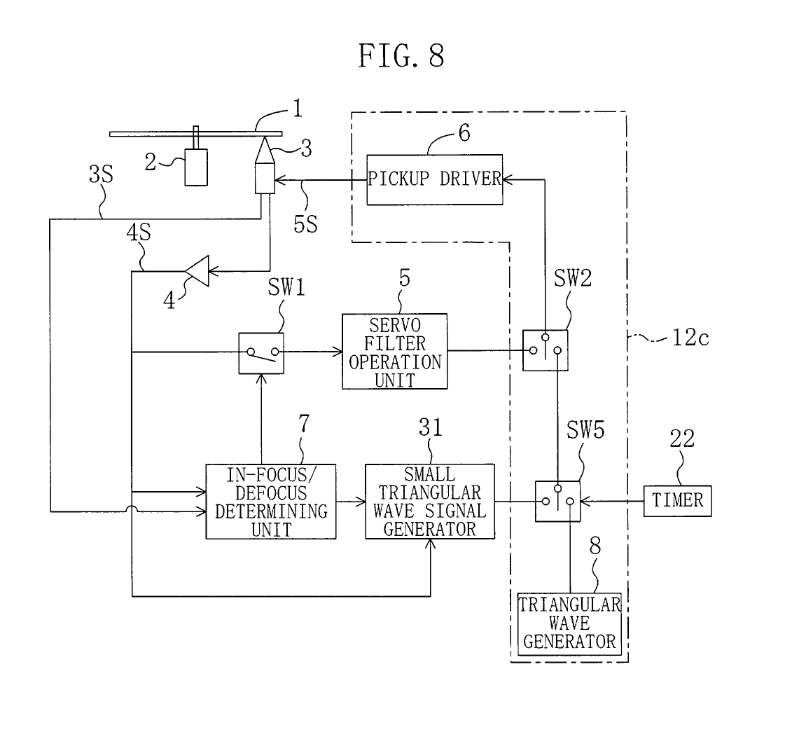

Hereinafter, the third embodiment of the present invention will be described with reference to FIG. 8.

FIG. 8 is a block diagram showing the structure of a disk drive device according to the third embodiment. In the disk drive device of FIG. 8, the same components as those in FIGS. 1 and 4 are denoted with the same reference numerals and characters. The disk drive device of FIG. 8 additionally includes a small triangular wave signal generator 31 (corresponding to a small drive signal generating means) and a switch SW5. The switch SW5 is switched between the small triangular wave signal generator 31 and the triangular wave generator 8. A drive output generating means 12c is formed by the pickup driver 6 and the triangular wave generator 8.

In the initial state, the servo ON/OFF switch SW1 is in the ON state, the driver output switch SW2 selects the switch SW5, and the switch SW5 selects the triangular wave generator 8. In response to an instruction to start the focus control, a focus servo operation is conducted in the same manner as that in the first embodiment.

When the pickup 3 is in the in-focus region in the focus servo operation, the servo ON/OFF switch SW1 is in the ON state, and the driver output switch SW2 selects the servo filter operation unit 5. The in-focus/defocus determining unit 7 keeps track of a focus error signal 4S and various read signals 3S to determine whether the pickup 3 is in the in-focus region or in the defocus region. If the in-focus/defocus determining unit 7 determines that the pickup 3 moves into the defocus region due to vibration or the like, the servo ON/OFF switch SW1 is turned OFF, and the driver output switch SW2 is switched to the switch SW5. The switch SW5 is switched to the small triangular wave generator 31. The small triangular wave generator 31 outputs a triangular wave smaller than that used for the normal focus scanning operation (corresponding to a small drive signal) to the pickup driver 6. The pickup driver 6 outputs to the pickup 3 a focus drive signal 5S for driving the pickup 3 with an amplitude smaller than the normal amplitude. As a result, the focus scanning operation of the pickup 3 is conducted with an amplitude smaller than the normal amplitude. At the same time, the timer 22 starts a counting operation. The timer 22 discontinues the counting operation when restoration of the focus servo operation is completed. If restoration of the focus servo operation is not completed at a prescribed count value or more, it is determined that any trouble occurred during the focus scanning operation with the small triangular wave. In this case, the switch SW5 is switched to the triangle wave generator 8, whereby the disk drive device proceeds to a normal focus scanning operation to restore the focus servo operation.

As modifications of the third embodiment, the disk drive device may proceed to the normal focus scanning operation in the same manner as that in the modifications of the second embodiment. More specifically, as in the case of FIG. 6, the S-shape detector 23 (corresponding to an S-shape detecting means) is added to the disk drive device of FIG. 8. Alternatively, as in the case of FIG. 7, the S-shape detector 23 is added to the disk drive device of FIG. 8 and the timer 22 is replaced with the S-shape counter 24. As soon as the focus scanning operation of the pickup 3 is started with an amplitude smaller than the normal amplitude, the S-shape detector 23 starts detecting the S-shaped waveform of the focus error signal 4S. Thereafter, the timer 22 or the S-shape counter 24 operates in the same manner as that described in connection with the modifications of the second embodiment. In this way, the disk drive device proceeds to the normal focus scanning operation.

As has been described above, if the focus servo operation is discontinued in the third embodiment, a focus scanning operation is conducted with an amplitude smaller than the normal amplitude rather than conducting the normal focusing scanning operation.

This facilitates restoration of the pickup to the in-focus region, and also increases the number of chances to detect a proper focus error signal. As a result, the time required to restore the focus servo operation can be reduced. Moreover, the focus scanning operation is conducted while driving the pickup with small driving force. This enables the focus servo operation to be restored even if the center of the pickup for the focus scanning operation is displaced from the vibration center of the pickup.

(Fourth Embodiment)

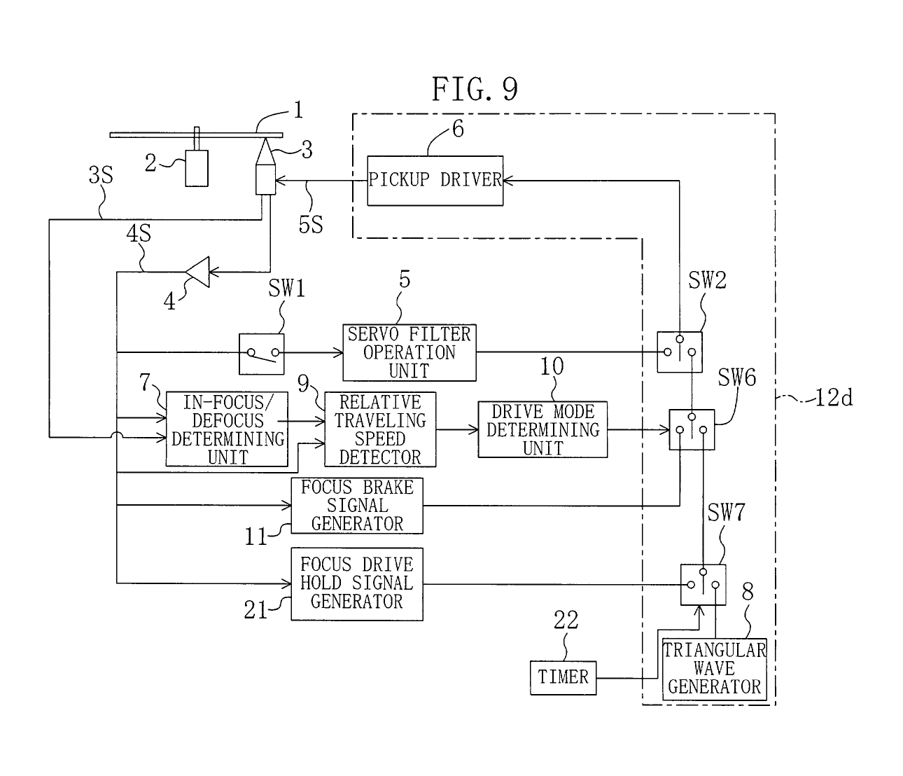

Hereinafter, the fourth embodiment of the present invention will be described with reference to FIG. 9.

FIG. 9 is a block diagram showing the structure of a disk drive device according to the fourth embodiment. In the disk drive device of FIG. 9, the same components as those in FIGS. 1, 4 and 8 are denoted with the same reference numerals and characters. The disk drive device of FIG. 9 additionally includes switches SW6, SW7. The switch SW6 is switched between the focus brake signal generator 11 and the switch SW7. The switch SW7 is switched between the focus drive hold signal generator 21 and the triangular wave generator 8. A drive output generating means 12d is formed by the pickup driver 6 and the triangular wave generator 8.

In the initial state, the servo ON/OFF switch SW1 is in the ON state, the driver output switch SW2 selects the switch SW6, and the switch SW6 selects the switch SW7. The switch SW7 selects the triangular wave generator 8. In response to an instruction to start the focus control, a focus servo operation is conducted in the same manner as that in the first embodiment.

When the pickup 3 is in the in-focus region in the focus servo operation, the servo ON/OFF switch SW1 is in the ON state, and the driver output switch SW2 selects the servo filter operation unit 5. The in-focus/defocus determining unit 7 keeps track of a focus error signal 4S and various read signals 3S to determine whether the pickup 3 is in the in-focus region or in the defocus region. If the in-focus/defocus determining unit 7 determines that the pickup 3 moves into the defocus region due to vibration or the like, the servo ON/OFF switch SW1 is turned OFF, and the driver output switch SW2 is switched to the switch SW6. Note that the switch SW6 already selects the switch SW7. The switch SW7 is switched to the focus drive hold signal generator 21. The focus drive hold signal generator 21 holds a focus drive signal 5S output from the pickup driver 6. Like the second embodiment, the timer 22 starts a counting operation as soon as the focus drive hold signal generator 21 holds the focus drive signal 5S. The timer 22 discontinues the counting operation when the pickup 3 returns to the in-focus region and restoration of the focus servo operation is completed. If restoration of the focus servo operation is not completed at a prescribed count value or more, the switch SW7 is switched to the triangle wave generator 8, whereby the disk drive device proceeds to a normal focus scanning operation to restore the focus servo operation.

If the in-focus/defocus determining unit 7 determines that the pickup 3 reaches the in-focus region during generation of the focus drive hold signal, the relative traveling speed detector 9 detects the traveling speed of the pickup 3 relative to the disk 1, as in the first embodiment. If the drive mode determining unit 10 determines that the pickup 3 moves slowly relative to the disk 1 and the drive mode of the pickup 3 is a mode for conducting the focus servo operation, the servo ON/OFF switch SW1 is turned ON and the driver output switch SW2 is switched to the servo filter operation unit 5, whereby the disk drive device proceeds to the operation of restoring the focus servo operation. On the other hand, if the drive mode determining unit 10 determines that the pickup 3 moves rapidly relative to the disk 1 and the drive mode of the pickup 3 is a brake mode, the switch SW6 is switched to the focus brake signal generator 11. The focus brake signal generator 11 applies a brake pulse to the pickup driver 6. When application of the brake pulse is completed, the disk drive device proceeds to the operation of restoring the focus servo operation in the same manner as that of the first embodiment.

Note that, according to the present embodiment, if the in-focus/defocus determining unit 7 determines that the pickup 3 is in the defocus region due to vibration or the like, the switch SW7 is switched to the focus drive hold signal generator 21 to hold the focus drive signal 5S. In the present embodiment, however, the focus drive hold signal generator 21 may be replaced with the small triangular wave signal generator 31 for generating a small triangular wave signal.

As has been described above, the disk drive device of the present embodiment has the functions of the disk drive devices of the first to third embodiments. Therefore, the time required to restore the focus servo operation can further be reduced.

What is claimed is:

1. A disk drive device, comprising:
a pickup for outputting laser light to a disk for reading data recorded on the disk;
a relative traveling speed detecting means for receiving a focus error signal indicating a displacement amount of the pickup from an in-focus position and detecting a traveling speed of the pickup relative to the disk;
a drive mode determining means for receiving the detected relative traveling speed and determining a drive mode of the pickup according to the received relative traveling speed; and
a drive output generating means for generating a focus drive signal for driving the pickup according to the drive mode.

2. The disk drive device according to claim 1, wherein the drive mode determining means determines that the drive mode is a brake mode when the relative traveling speed is greater than a prescribed value, and determines that the drive mode is a mode for restoring a focus servo operation when the relative traveling speed is smaller than the prescribed value.

3. The disk drive device according to claim 1, wherein the relative traveling speed detecting means detects the relative traveling speed by measuring a time required for the focus error signal to reach a second threshold value after becoming higher or lower than a first threshold value.

4. The disk drive device according to claim 1, wherein the relative traveling speed detecting means detects the relative traveling speed by measuring a gradient of the focus error signal between a first preset value and a second preset value of the focus error signal.

5. A disk drive device, comprising:
a pickup for outputting laser light to a disk for reading data recorded on the disk;
an in-focus/defocus determining means for receiving a focus error signal indicating a displacement amount of the pickup from an in-focus position and an output signal of the pickup, and determining whether the pickup is in an in-focus region or in a defocus region;
a drive output generating means for generating a focus drive signal for driving the pickup; and
a focus drive hold signal generating means for generating a focus drive hold signal for holding the focus drive signal when the in-focus/defocus determining means determines that the pickup is in the defocus region, wherein
the drive output generating means holds the focus drive signal in response to the focus drive hold signal.

6. A disk drive device, comprising:
a pickup for outputting laser light to a disk for reading data recorded on the disk;
an in-focus/defocus determining means for receiving a focus error signal indicating a displacement amount of the pickup from an in-focus position and an output signal of the pickup, and determining whether the pickup is in an in-focus region or in a defocus region;
a drive output generating means for generating a focus drive signal for driving the pickup; and
a small drive signal generating means for generating a small drive signal for driving the pickup with an amplitude smaller than a normal amplitude, when the in-focus/defocus determining means determines that the pickup is in the defocus region, wherein
the drive output generating means generates a focus drive signal for driving the pickup with an amplitude smaller than the normal amplitude, in response to the small drive signal.

7. The disk drive device according to any one of claims 1, 5 and 6, further comprising:
a counting means for detecting whether or not restoration of a focus servo operation is completed within a prescribed time after an operation of restoring the focus servo operation is started, wherein
when the counting means detects that restoration of the focus servo operation is not completed within the prescribed time, the disk drive device discontinues the operation of restoring the focus servo operation and proceeds to another operation of restoring a focus servo operation.

8. The disk drive device according to any one of claims 1, 5 and 6, further comprising:
an S-shape detecting means for detecting an S-shaped waveform of the focus error signal; and
a counting means for measuring a time required for the S-shape detecting means to detect the S-shaped waveform, wherein
when the time measured by the counting means exceeds a prescribed value, the disk drive device proceeds to another operation of restoring a focus servo operation.

9. The disk drive device according to any one of claims 1, 5 and 6, further comprising:
an S-shape detecting means for detecting an S-shaped waveform of the focus error signal; and
an S-shape counter for counting the number of times the S-shape detecting means detects the S-shaped waveform, wherein
when the count value of the S-shape counter exceeds a prescribed value, the disk drive device proceeds to another operation of restoring a focus servo operation.
